(19) United States
(12) Patent Application Publication
(10) Pub. No.: US 2010/0146355 A1
(43) Pub. Date: Jun. 10, 2010

(54) Retransmission Method, Communication System, and Transmission Device

(75) Inventors: Hao Jiang, Beijing (CN); Ming Xu, Beijing (CN); Kenichi Kuri, Osaka (JP); Akihiko Nishio, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, OSAKA (JP)

(21) Appl. No.: 12/595,433

(22) PCT Filed: Apr. 11, 2008
(86) PCT No.: PCT/JP2008/000959

§ 371 Date: Feb. 4, 2010

(30) Foreign Application Priority Data
Apr. 11, 2007 (CN) 200710091776.9

(51) Int. Cl. H04L 1/18; G06F 11/14

(52) U.S. Cl. 714/749; 714/E11.113

(57) ABSTRACT

Disclosed are a retransmission method and a communication system which can realize a preferable trade-off between the feedback information amount and the error ratio characteristic. In the communication system, an encoding unit (703) packetizes an channel coding codeword inputted from a signal source (701) and generates a plurality of packets each formed by one or more encoded bit contained in the channel coding codeword. When it is judged that a decoding error has occurred, a retransmission judgment unit (719) selects one packet having the least likelihood among the packets constituting the channel coding codeword received via a reception antenna (713) and feeds the packet number of the selected packet together with NACK back to a transmission device (150). The transmission device (150) retransmits a packet corresponding to the packet number fed back from the reception device (160) and a redundant version.

### TECHNICAL FIELD

The present invention relates to HARQ (Hybrid Automatic Repeat reQuest) technology in the field of communication.

### BACKGROUND ART

In a wireless communication environment, fading, which is caused by transfer of communication terminals and channel noise, and interference by other users cause degradation of channel transmission quality. Therefore, to ensure communication quality, protection needs to be applied to data information. This protection mainly adopts FEC (Forward Error Correction), that is, redundancy check bits are included in packets and transmitted. Although FEC improves the reliability of systems, when channel conditions are good, excessive redundancy bits decreases the throughput of systems.

On the other hand, ARQ (Automatic Repeat reQuest) is a transmission mechanism for requesting a retransmission when a data transmission fails. According to ARQ, although an ideal throughput can be achieved when there are not so many error bits, extra delay is caused.

HARQ (hybrid automatic repeat request) is a technique combining above-described FEC (Forward Error Correction) and ARQ (Automatic Repeat reQuest). That is, HARQ takes the FEC subsystem into the ARQ system and improves ARQ. As described above, these FEC subsystems are used to correct errors and reduce the number of retransmissions. According to HARQ, check bits for error detection and correction are included in codewords to the transmitted. When the number of error bits included in a received packet is within the range of the error correction performance, the receiving side corrects errors automatically, while, when serious errors occur that are beyond the error correction performance of FEC, the receiving side requests a retransmission to the transmitting side.

Also, while HARQ can automatically adapt to the channel conditions, HARQ is not likely to be influenced by a measurement error and delay, thereby improving the reliability of systems and improving the transmission efficiency of systems.

There are three types of HARQ: TYPE I HARQ, TYPE II HARQ (Type II Hybrid Automatic Retransmission reQuest) and TYPE III HARQ (see Non-Patent Document 1). In an actual system, it is possible to select a HARQ type based on the system performance and the complexity of equipment.

TYPE I HARQ is also referred to as “traditional ARQ,” and its main concept is to change the bit rate of forward error correction bits by limitation of system requirements such as the signal to noise ratio. FIG. 1 is a diagram illustrating TYPE I HARQ. In FIG. 1, a base station (“BS”) is illustrated as an example of the transmitting side, and a mobile station (“MS”), that is, user equipment (“UE”) is illustrated as an example of the receiving side.

If the result of receiving and decoding a codeword initially transmitted from the transmitting side is an error, the receiving side discards the codeword and requests a retransmission of the codeword to the transmitting side by feeding back a negative acknowledgement signal (“NACK signal”) in the uplink. When receiving the retransmission request, the transmitting side retransmits the codeword that was previously transmitted, until the transmitting side receives an acknowledgement signal (“ACK signal”) fed back from the receiving side. When receiving the codeword and decoding it correctly, the receiving side feeds back an ACK signal to the transmitting side. When receiving the ACK fed back from the receiving side, the transmitting side transmits a new codeword. In TYPE I HARQ, the receiving side does not combine a codeword received earlier and redundancy information received currently. For TYPE I HARQ, the installation cost is very cheap, and the physical layer structure and decoding operations are relatively simple. However, this fixed forward error correction coding involves fixed redundancy information, and, consequently, the throughput of systems using TYPE I HARQ is inferior to that of systems using TYPE II HARQ or TYPE III HARQ, which will be described later.

TYPE II HARQ belongs to the IR (Incremental Redundancy) ARQ mechanism. FIG. 2 is a diagram illustrating TYPE II HARQ. In IR-ARQ, the receiving side does not discard but stores a codeword that causes a decoding error, and requests a retransmission to the transmitting side by feeding back a NACK signal on the uplink. Upon receiving the retransmission request, the transmitting side transmits redundancy information such as RV (Redundancy Version) I and RV 2 until the transmitting side receives an ACK fed back from the receiving side. Here, redundancy information differs from the initially-transmitted codeword. If the result of receiving the redundancy information, combining it and the initially-received codeword and decoding the combination result does not cause a decoding error, the receiving side feeds back an ACK signal to the transmitting side. Thus, in HARQ, the receiving side combines newly-received redundancy information and a codeword received earlier, to form a forward error correction code of higher error correction performance, thereby reducing error bits. The mechanism of TYPE II HARQ belongs to incremental redundancy HARQ of the overall redundancy system, and retransmitted bits do not include systematic bits but include only new redundancy information (i.e. check bits). The system of TYPE II HARQ normally provides many kinds of redundancy versions.

TYPE III HARQ is also referred to as “partial redundancy HARQ,” and similarly belongs to the IR-HARQ mechanism. FIG. 3 is a diagram illustrating TYPE III HARQ. As shown in FIG. 3, TYPE III HARQ is similar to TYPE II HARQ in not discarding but storing a codeword in which a decoding error has occurred in the receiving side, combining the codeword with following retransmitted data and decoding the combination result. However, in TYPE III HARQ, unlike TYPE II HARQ, retransmitted data includes a self-decodable codeword in TYPE I HARQ in addition to redundancy information. Also, a retransmitted codeword in TYPE III HARQ includes different parity bits from the parity bits included in the initially-transmitted codeword. By performing decoding using only a retransmitted codeword, it is possible to directly decode user information from the retransmitted codeword, and, if decoding is not performed correctly, the codeword is chase-combined with a codeword transmitted earlier. Here, if decoding is not still performed correctly, a retransmission is then requested. Compared to TYPE HARQ and TYPE II HARQ, TYPE III HARQ is more difficult to implement.

Although TYPE I HARQ is used in early WCDMA (Wideband Code Division Multiple Access), TYPE III HARQ is used in recent extended versions of WCDMA such as HSDPA/HSUPA (High Speed Downlink Packet Access/High Speed Uplink Packet Access). By transmitting a new redundancy version, TYPE II/III HARQ transmits a codeword with a lower bit rate than the codeword transmitted previously, thereby improving the error correction performance. That is, even if the previous decoding processing fails, when the channel conditions are good and there are not so many error bits included in a received codeword, the receiving side can perform decoding correctly only by retransmitting a small amount of error bits. By contrast, when the channel conditions are poor and there are many error bits, the receiving side is still less likely to perform decoding correctly even by retransmitted redundancy bits, and the number of retransmissions in the system increases, which lowers the overall system throughput. However, in TYPE III HARQ, the number of bits included in the redundancy version used every retransmission is fixed, and, consequently, the number of bits actually retransmitted may be greater than the number of bits required to be retransmitted, which can lower the retransmission efficiency.

On the other hand, with development of FEC technology, channel coding schemes of soft-in/soft-out decoding algorithms including a Turbo code and LDPC code (Low Density Parity-Cheek code), can approach the Shannon limit more closely, so that these channel coding schemes have attracted attention and are often used in the latest communication standards.

The decoding section of these channel coding schemes outputs soft information, that is, the positive/negative sign of the logarithm likelihood ratio of each encoded bit represents a hard decision value, and the absolute values of the logarithm likelihoods represents the reliability of the encoded bits. The hybrid automatic retransmission request based on reliability information to indicate the reliability (i.e. RB-HARQ: Reliability Based-HARQ) has been suggested (see Non-Patent Document 2). FIG. 4 is a diagram illustrating conventional RB-HARQ. In RB-HARQ, the receiving side rearranges the LLR's of encoded bits outputted from a decoding section based on their absolute values, and feeds back the bit index of the encoded bit of the lowest reliability, as information about the position of the encoded bit. In FIG. 4, an LDPC code is used as an example of an encoded bit, and, for example, the column numbers of k bits of the LDPC code are fed back as bit indices. On the other hand, the transmitting side retransmits only encoded bits matching the bit indices fed back from the receiving side. Further, the receiving side combines the retransmitted, encoded bits and the encoded bits received earlier, and decodes the combination result. Therefore, compared to TYPE III HARQ, RB-HARQ can further improve the retransmission efficiency and the error bit performance of systems.

Non-Patent Document 1: 3G TR 25.835 V1.0.0, 2000, September Non-Patent Document 2: Yoichi Inaba and et al. Reliability-Based Hybrid ARQ (RB-HARQ) Schemes using Low-Density Parity-Check (LDPC) Codes. IEEE GLOBECOM 2006 proceedings

### DISCLOSURE OF INVENTION

### Problems to be Solved by the Invention

However, conventional RB-HARQ needs to feed back the bit index of each encoded bit, and, especially when the code length is long, the amount of information fed back from the receiving side is enormous.

Also, although conventional TYPE II/III HARQ improves the error correction performance of an entire codeword by retransmitting a given redundancy version (“RV”) to the receiving side, in predetermined conditions, conventional TYPE II/III HARQ is influenced by error bits included in the codeword received previously, which may cause errors in decoding processing again after a retransmission.

It is therefore an object of the present invention to provide a retransmission method, communication system and transmitting apparatus that can solve the trade-off between the amount of feedback information and error rate performance, reduce the number of retransmissions and improve the overall system throughput, so as to limit an increased amount of feedback information and achieve superior error rate performance over conventional TYPE II HARQ.

### Means for Solving the Problem

The retransmission method of the present invention includes: a generating step of, in a transmitting side, packetizing a channel coding codeword and generating a plurality of packets comprised of one or a plurality of encoded bits included in the channel coding codeword; an initial transmission step of, in the transmitting side, performing an initial transmission of the channel coding codeword; an initial decoding step of, in a receiving side, receiving and performing initial decoding of the channel coding codeword; an initial selection step of, when a decoding error has occurred in the initial decoding step, selecting one packet of the lowest reliability amongst the plurality of packets; a packet number feedback step of feeding back a negative acknowledgement signal and a packet number of the selected one packet from the receiving side to the transmitting side; and a packet retransmitting step of, in the transmitting side, retransmitting encoded bits included in a packet matching the packet number and a redundancy version.

Further, the retransmission method of the present invention includes: a generating step of, in a transmitting side, packetizing a channel coding codeword and generating a plurality of packets comprised of one or a plurality of encoded bits included in the channel coding codeword; an initial transmission step of, in the transmitting side, performing an initial transmission of the channel coding codeword; an initial decoding step of, in a receiving side, receiving and performing initial decoding of the channel coding codeword; a calculating step of, when a decoding error has occurred in the initial decoding step, deciding a reliability of each encoded bit included in the channel coding codeword and calculating the number of bits of low reliability; a position information feedback step of, in the receiving side, when the number of bits of low reliability is equal to or less than a first threshold, feeding back a negative acknowledgement signal and information about positions of the bits of low reliability; a packet number feedback step of, in the receiving side, when the number of bits of low reliability is greater than the first threshold, selecting one packet of the lowest reliability and feeding back a negative acknowledgement signal and a packet number of the selected one packet to the transmitting side; a bit retransmitting step of, in the transmitting side, when the negative acknowledgement signal and the information about the positions of the bits of low reliability are fed back from the receiving side, retransmitting the bits of low reliability based on the information about the positions of the bits of low reliability; and a packet retransmitting step of, in the transmitting side, when the negative acknowledgement signal and the packet number are fed back from the receiving side, retransmitting encoded bits included in a packet matching the packet number and a redundancy version.

Further, the retransmission method of the present invention includes: a generating step of, in a transmitting side, packetizing a channel coding codeword and generating a plurality of packets comprised of one or a plurality of encoded bits included in the channel coding codeword; an initial transmission step of, in the transmitting side, performing an initial transmission of the channel coding codeword; an initial decoding step of, in a receiving side, receiving and performing initial decoding of the channel coding codeword; a calculating step of, when a decoding error has occurred in the initial decoding step, deciding a reliability of each encoded bit included in the channel coding codeword and calculating the number of bits of low reliability; a position information feedback step of, in the receiving side, when the number of bits of low reliability is equal to or less than a first threshold, feeding back a negative acknowledgement signal and information about positions of the bits of low reliability; a start signal feedback step of, in the receiving side, when the number of bits of low reliability is greater than a predetermined threshold, feeding back a negative acknowledgement signal and a start signal for a type II hybrid automatic retransmission request to the transmitting side; a bit retransmitting step of, in the transmitting side, when the negative acknowledgement signal and the information about the positions of the bits of low reliability are fed back from the receiving side, retransmitting the bits of low reliability based on the information about the positions of the bits of low reliability; and a redundancy version retransmitting step of, in the transmitting side, when the negative acknowledgement signal and the start signal for the type II hybrid automatic retransmission request are fed back from the receiving side, retransmitting a redundancy version.

The communication system of the present invention employs a configuration having a transmitting apparatus and receiving apparatus, in which the transmitting apparatus includes: a generating section that packetizes a channel coding codeword and generates a plurality of packets comprised of one or a plurality of encoded bits included in the channel coding codeword; an initial transmission section that performs an initial transmission of the channel coding codeword; and a packet retransmitting section that, when a packet number and negative acknowledgment signal are fed back from the receiving apparatus, retransmits encoded bits included in a packet matching the packet number and a redundancy version, and in which the receiving apparatus includes: a decoding section that receives and decodes the channel coding codeword; an initial selection section that, when a decoding error has occurred in the decoding step, selects one packet of the lowest reliability amongst the plurality of packets; and a packet number feedback section that feeds back the negative acknowledgement signal and the packet number of the selected one packet to the transmitting apparatus.

The transmitting apparatus of the present invention employs a configuration having: a generating section that packetizes a channel coding codeword and generates a plurality of packets comprised of one or a plurality of encoded bits included in the channel coding codeword; an initial transmission section that performs an initial transmission of the channel coding codeword; and a packet retransmitting section that, when a packet number and negative acknowledgment signal are fed back from a receiving apparatus, retransmits encoded bits included in a packet matching the packet number and a redundancy version.

### ADVANTAGEOUS EFFECT OF INVENTION

According to the present invention, it is possible to limit an increased amount of feedback information, achieve the superior error rate performance over conventional TYPE II HARQ and realize a good tradeoff between the amount of feedback information and error rate performance, thereby reducing the number of retransmissions and improving the overall system throughput.

### BRIEF DESCRIPTION OF DRAWINGS

FIG. 1 is a diagram illustrating conventional TYPE I HARQ;

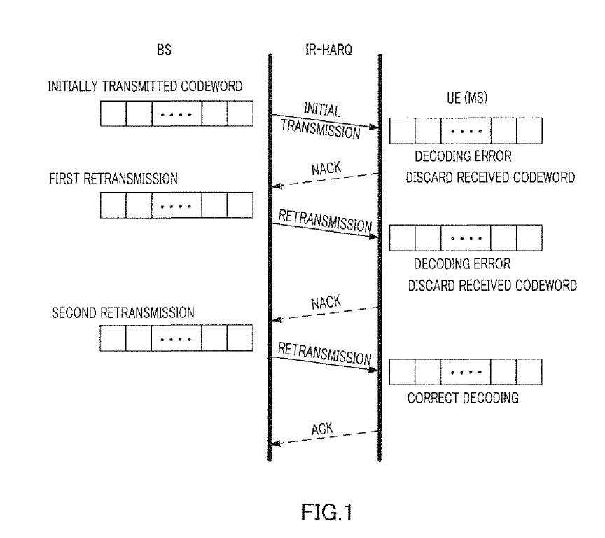

FIG. 2 is a diagram illustrating conventional TYPE II HARQ;

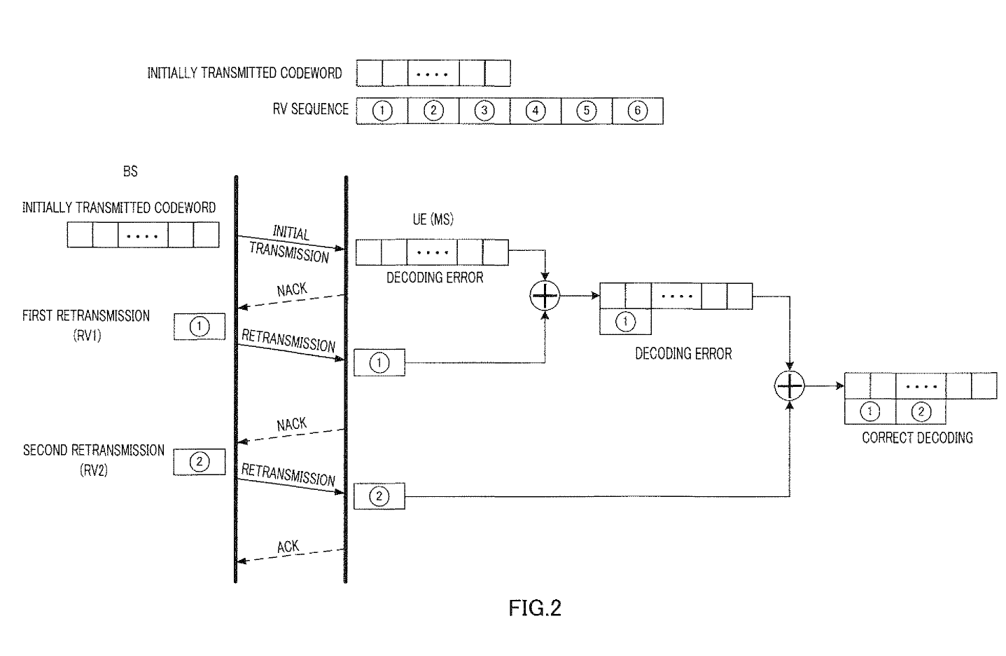

FIG. 3 is a diagram illustrating conventional TYPE III HARQ;

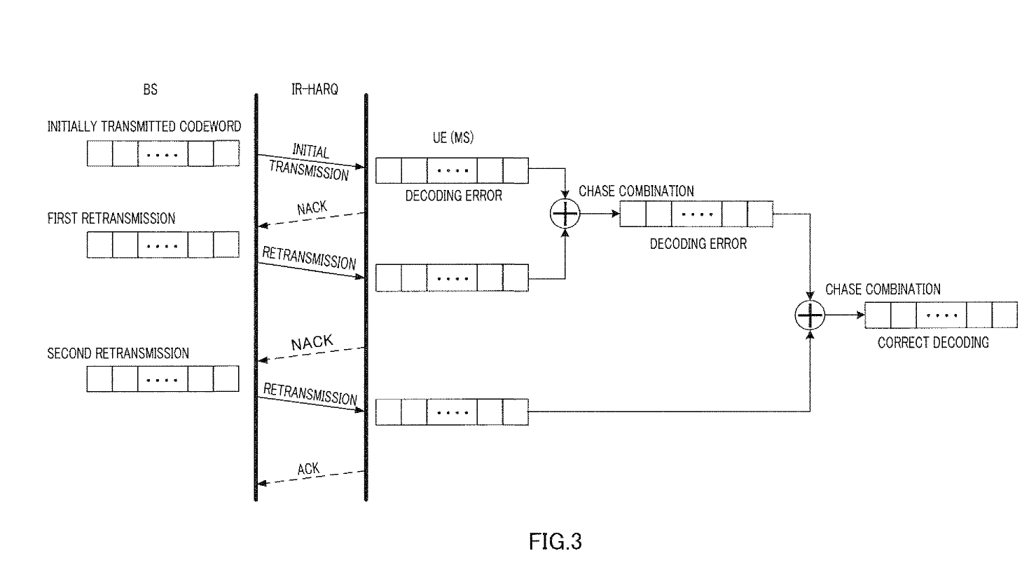

FIG. 4 is a diagram illustrating conventional RB-HARQ;

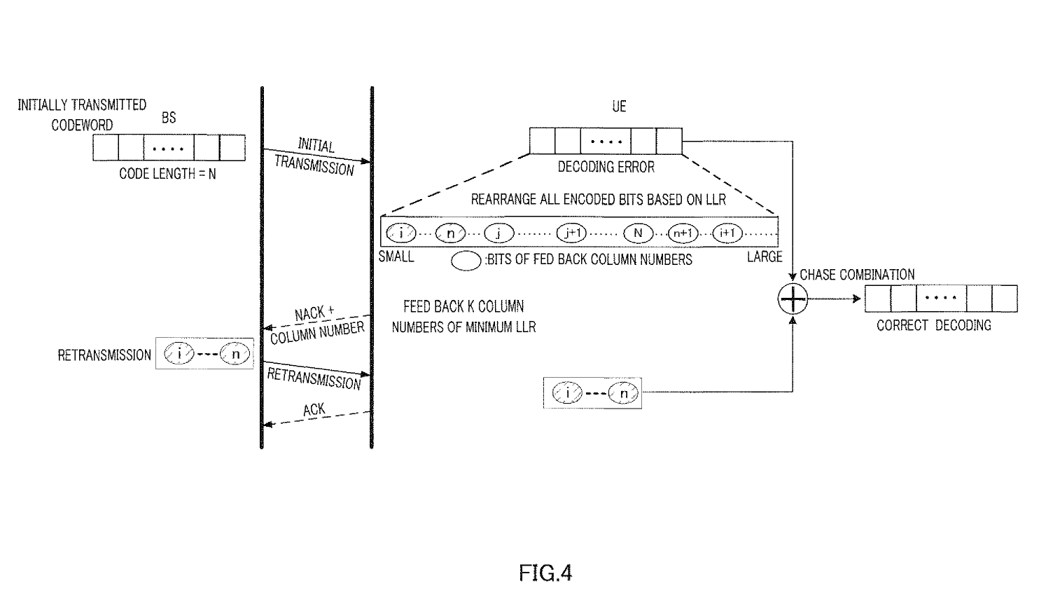

FIG. 5 is a diagram illustrating pocketing RB-HARQ according to an embodiment of the present invention;

FIG. 6 is a flowchart showing the steps of packeting RB-HARQ according to an embodiment of the present invention;

FIG. 7 is a block diagram showing the main components of a communication system to realize pocketing RB-HARQ according to an embodiment of the present invention;

FIG. 8 is a block diagram showing the configuration inside a retransmission determining section according to an embodiment of the present invention;

FIG. 9 is a flowchart showing the steps of selecting one of conventional RB-HARQ and conventional TYPE II HARQ and performing retransmission;

FIG. 10 illustrates a state where RB-HARQ is selected to perform retransmission when the number of bits of low reliability is equal to or less than second threshold T2 in the processing steps of FIG. 9;

FIG. 11 illustrates a state where TYPE II HARQ is selected to perform retransmission when the number of bits of low reliability is greater than second threshold T2 in the processing steps of FIG. 9; and

FIG. 12 is a flowchart showing the steps of selecting one of conventional RB-HARQ and pocketing RB-HARQ according to the present invention and performing retransmission.

### BEST MODE FOR CARRYING OUT THE INVENTION

An embodiment of the present invention will be explained below in detail with reference to the accompanying drawings.

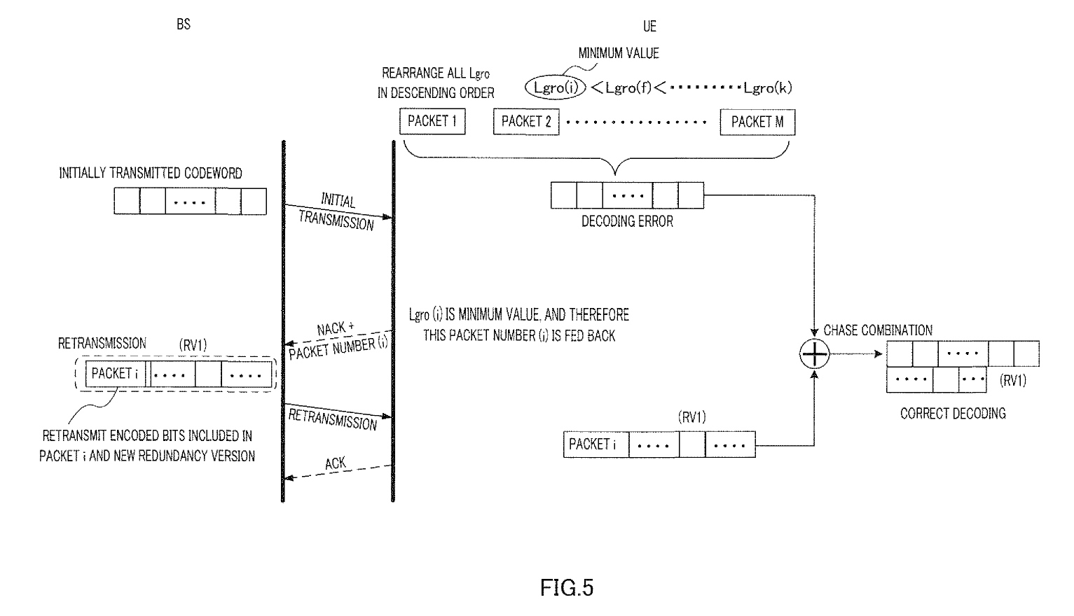

FIG. 5 is a block diagram showing pocketing RB-HARQ according to an embodiment of the present invention.

In FIG. 5, the receiving side receives and decodes the channel coding codeword initially transmitted from the transmitting side and performs following processing 1 or 2 based on the decoding result. Here, although a convolutional code, turbo code, LDPC code or RA (Repeat Accumulate) code is used as the channel coding codeword, the channel coding codeword is not limited to these.

Processing 1

If the decoding operations succeed, the receiving side feeds back an ACK signal to report that the receiving side received the transmitted signal correctly. Immediately after receiving the ACK signal, the transmitting side starts the next, new transmission.

Processing 2

If the decoding operations fail, the receiving side selects the packet of the lowest reliability amongst the packets forming the received channel coding codeword. As a selection method, when packets are arranged in descending order of L_{gro}, and, for example, L_{gro} [symbol] _{gro}(j)≦ . . . [symbol] _{gro}(k) is found, the packet of the lowest L_{gro}, that is, the packet i is selected. Here, L_{gro} represents the average value of the absolute values of the LLR's of encoded bits included in each packet. The receiving side feeds back the number of the selected packet and a NACK signal to the transmitting side, and the transmitting side retransmits the encoded bits included in the packet matching the packet number fed back from the receiving side, and a redundancy version (“RV”) to the receiving side at the same time.

Thus, packeting RB HARQ retransmits one packet of the lowest reliability in a codeword in which a decoding error has occurred. Then, like TYPE II HARQ, by chase-combining the same bit sequences received twice and combining the chase-combination result and the RV, the receiving side can produce a channel coding codeword of a lower coding rate, thereby achieving better error correction performance. If the result of decoding the bit sequence produced by the chase combination does not cause an error, the receiving side feeds back an ACK signal to the transmitting side.

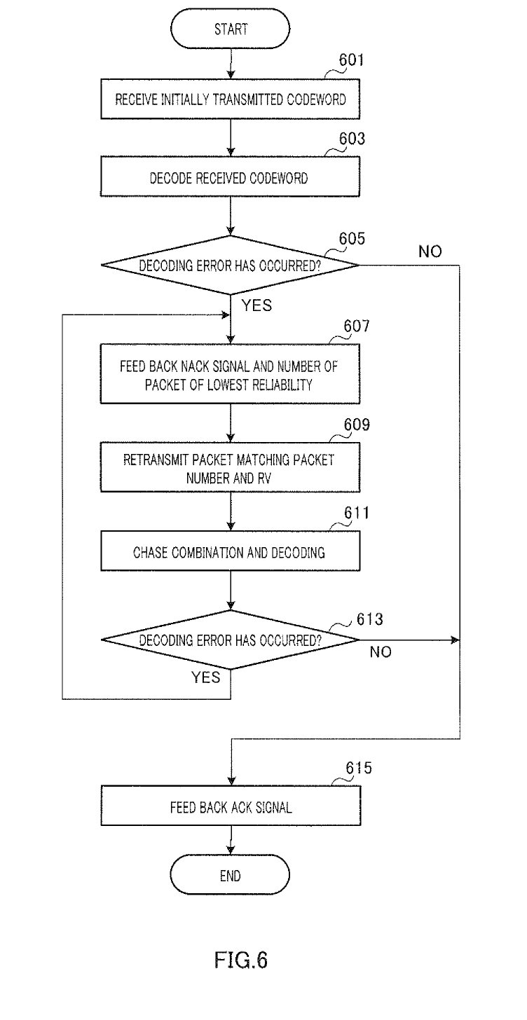

FIG. 6 is a flowchart showing the steps of packeting RB-HARQ according to an embodiment of the present invention.

First, in step 601, the receiving side receives the channel coding codeword initially transmitted from the transmitting side. Here, although a convolutional code, turbo code, LDPC code or RA code is used as the channel coding codeword, the channel coding codeword is not limited to these. Also, encoded bits included in a channel coding codeword are packetized into a plurality of packets, and each packet is an assembly comprised of one or a plurality of packets. This packeting result is known in the transmitting side and receiving side. The packeting method of a channel coding codeword is determined by the type of a codeword actually used. For example, referring to a LDPC code as an example, encoded bits can be packetized based on the column weights of encoded bits, the stopping set distribution, the cycle length, or the rows of the parity check matrix (check equation), but the packeting method is not limited to this.

Next, in step 603, the receiving side decodes the received channel coding codeword.

Next, in step 605, the receiving side decides whether or not a decoding error has occurred.

If it is decided that a decoding error has not occurred in step 605 (“NO” in step 605), in step 615, the receiving side feeds back an ACK signal to the transmitting side, and the transmitting side having received the ACK signal starts the next, new transmission.

By contrast, if it is decided that a decoding error has occurred in step 605 (“YES” in step 605), in step 607, the receiving side feeds back a NACK signal and the packet number of the packet of the lowest reliability amongst the packets forming the channel coding codeword, to the transmitting side. In this step, the method of selecting the packet of the lowest reliability includes calculating the average value of the absolute values of logarithm likelihood ratios (“LLR's”) of encoded bits included in each packet and selecting one packet of the lowest, calculated average value as the packet of the lowest reliability. Here, the selection method is not limited to the above example.

Next, in step 609, after receiving the packet number and NACK fed back from the receiving side, the transmitting side retransmits the encoded bits included in the packet corresponding to the packet number. Further, based on, for example, the method of TYPE II HARQ, the transmitting side selects and transmits the redundancy version (“RV”).

In step 611, the receiving side chase-combines the encoded bits retransmitted from the transmitting side and the encoded bits included in the channel coding codeword received previously, and further combines the chase-combination result and the redundancy version (“RV”) to generate a combined codeword of a lower coding rate, and performs decoding processing of the combined codeword.

Next, in step 613, the receiving side decides whether or not a decoding error has occurred.

In step 613, if the receiving side decides that a decoding error has not occurred (“NO” in step 613), the step proceeds to step 615.

By contrast, if the receiving side decides that a decoding error has occurred (“YES” in step 613), the step returns to step 607.

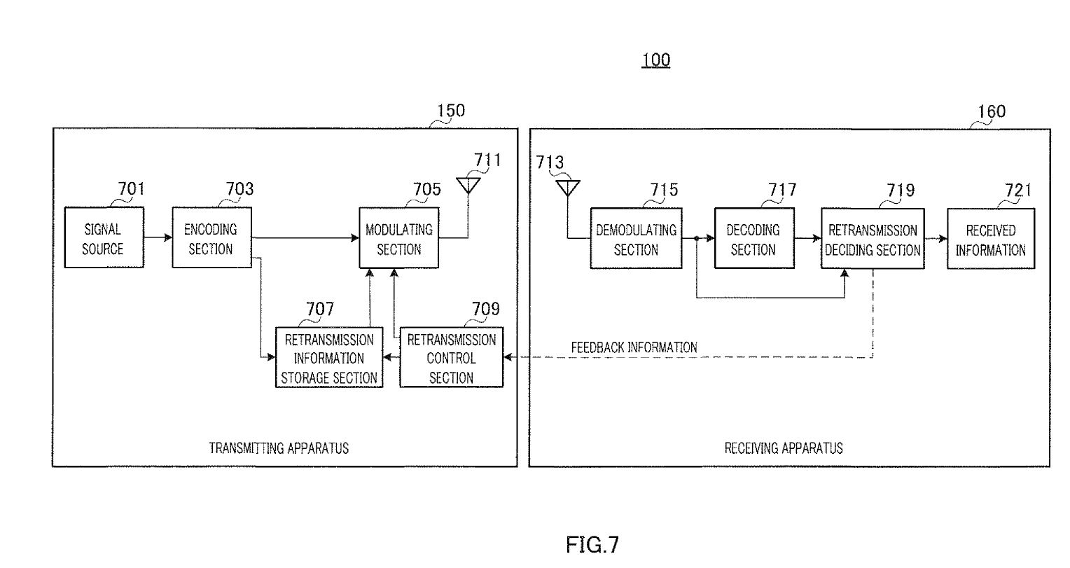

FIG. 7 is a block diagram showing the main components of communication system 100 as an example of a communication system to realize the retransmission method according to an embodiment of the present invention.

In FIG. 7, communication system 100 is provided with transmitting apparatus 150 and receiving apparatus 160. Here, transmitting apparatus 150 is provided with signal source 701, encoding section 703, modulating section 705, retransmission information storage section 707, retransmission control section 709 and transmitting antenna 711. Receiving apparatus 160 is provided with receiving antenna 713, demodulating section 715, decoding section 717, retransmission deciding section 719 and received information 721.

Signal source 701 generates and outputs an information bit stream to encoding section 703.

Encoding section 703 performs channel coding of the information bit stream received as input from signal source 701, packetizes the resulting channel coding codeword, and outputs the channel coding codeword and information about packets to modulating section 705 and retransmission information storage section 707.

Modulating section 705 maps the encoded bits to the constellation points, that is, maps the encoded bits to modulation symbols using the channel coding codeword and information about packets received as input from encoding section 703 or using packets and redundancy version received as input from retransmission information storage section 707, and outputs the resulting modulation symbols to transmitting antenna 711.

Retransmission information storage section 707 stores the channel coding codeword and information about packets input from encoding section 703, and all redundancy versions (RV's).

Transmitting antenna transforms the modulation symbol received as input from modulating section 705 to a transmission signal and transmits it to receiving apparatus 160.

Receiving antenna 713 receives the transmission signal transmitted from the transmitting apparatus, transforms it to a modulation symbol and outputs the modulation symbol to demodulating section 715.

Demodulating section 715 demodulates the modulation symbol received as input from receiving antenna 713, that is, demaps the modulation symbol to encoded bits, outputs a channel coding codeword comprised of the resulting encoded bits to decoding section 717 and retransmission deciding section 719, and outputs information about packets to retransmission deciding section 719.

Decoding section 717 performs channel coding using the channel coding codeword received as input from demodulating section 715, and outputs the resulting information bit stream to retransmission deciding section 719.

Retransmission deciding section 719 decides whether or not the decoding result is correct, using the information bit stream received as input from decoding section 717, that is, decides whether or not a decoding error has occurred, generates feedback information based on the decision result and feeds back the feedback information to transmitting apparatus 150. To be more specific, if retransmission deciding section 719 decides that the decoding result is correct, that is, a decoding error has not occurred, retransmission deciding section 719 outputs the information bit stream as received information 721 and feeds back an ACK signal to retransmission control section 709. By contrast, if retransmission deciding section 719 decides that the decoding result is not correct, that is, a decoding error has occurred, retransmission deciding section 719 selects the packet of the lowest reliability in the channel coding codeword received as input from demodulating section 715, using the information about packets received as input from demodulating section 715, and feeds back the packet number of the selected packet and a NACK signal to retransmission control section 709. The detailed configuration and operations of retransmission deciding section 719 will be described later.

Retransmission control section 709 of transmitting apparatus 150 performs retransmission operations based on the feedback information fed back from the receiving side. To be more specific, upon receiving a NACK signal and packet number fed back from retransmission deciding section 719, retransmission control section 709 extracts the packet corresponding to the fed back packet number, outputs the packet to modulating section 705 and outputs a retransmission redundancy version to modulating section 705. By contrast, upon receiving an ACK signal fed back from retransmission deciding section 719, retransmission control section 709 controls modulating section 705 to modulate a new codeword received as input from encoding section 703.

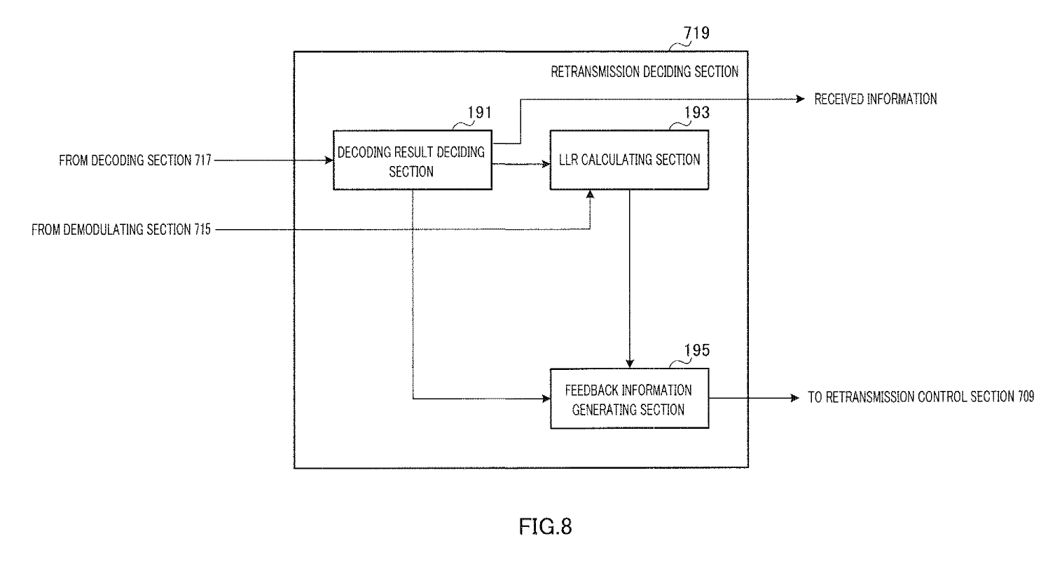

FIG. 8 is a block diagram showing the main components inside retransmission deciding section 719.

In FIG. 8, retransmission deciding section 719 is provided with decoding result deciding section 191, LLR calculating section 193 and feedback information generating section 195.

Using the information bit stream received as input from decoding section 717, decoding result deciding section 191 decides whether or not the decoding result is correct, that is, decides whether or not a decoding error has occurred, and outputs the decision result to LLR calculating section 193 and feedback information generating section 195. Further, upon deciding that decoding result is correct, decoding result deciding section 191 outputs the information bit stream as received information 721.

Upon receiving as input a decision result indicating a decoding error from decoding result deciding section 191, LLR calculating section 193 calculates the average value of the absolute values of the logarithm likelihood ratios (LLR's) of encoded bits included in each packet forming the channel coding codeword received as input from demodulating section 715, using the information about packets received as input from demodulating section 715. LLR calculating section 193 selects one packet of the lowest average value of the absolute LLR values, as the packet of the lowest reliability, and outputs the packet number of the selected packet to feedback information generating section 195.

If the decoding result received as input from decoding result deciding section 191 indicates correct decoding, feedback information generating section 195 generates an ACK signal as feedback information and feeds back it to retransmission control section 709. By contrast, if the decoding result received as input from decoding result deciding section 191 indicates a decoding error, feedback information generating section 195 generates and feeds back a NACK signal and the packet number received as input from LLR calculating section 193, to retransmission control section 709.

Thus, according to the present embodiment, when a decoding error has occurred on the receiving side, the receiving side feeds back the packet number of the packet of the lowest reliability amongst a plurality of packets forming the received channel coding codeword, to the transmitting side. Here, each packet is an assembly comprised of one or a plurality of encoded bits, and therefore the amount of feedback in packeting RB-HARQ according to the present invention is less than in RB-HARQ that feeds back the bit indices of encoded bits.

Further, according to the present embodiment, based on the packet number fed back from the receiving side, the transmitting side retransmits the encoded bits included in the packet, and redundancy version. That is, retransmission data received in the receiving side includes check bits included in the new RV in addition to the encoded bits included in the packet of the lowest reliability in the channel coding codeword received previously. Therefore, the reliability of the partial bit of the lowest reliability in the channel coding codeword previously received on the receiving side, is improved by a retransmission, thereby improving the reliability and error correction performance of the codeword newly received. That is, according to the present embodiment, it is possible to achieve better error rate performance.

Although an example case has been described above where the present embodiment takes into account only whether or not a decoding error has occurred, as a condition to return from step 613 to step 607 in FIG. 6, the present invention is not limited to this, and even if a decoding error does not occur and the number of retransmissions does not reach the maximum number of retransmissions defined in communication system 100, the processing flow may return from step 613 to step 607. Here, even after the number of retransmissions reaches the maximum number of retransmissions defined in communication system 100, if the decoding result is still not correct, the receiving side feeds back a negative acknowledgement signal (NACK) to the transmitting side.

Also, although an example ease has been described above with the present embodiment where the channel coding codeword is used as the transmission target, the present invention is not limited to this, and it is equally possible to use other encoded information as the retransmission target.

An embodiment of the present invention has been described above.

Also, by selecting between pocketing RB-HARQ according to an embodiment of the present invention, conventional RB-HARQ and conventional TYPE II HARQ depending on the situation, it is possible to further improve retransmission performance.

According to such a retransmission method, the receiving side uses two thresholds of T1 and T2.

Here, the first threshold T1 is used to decide whether or not each encoded bit outputted from the decoding section on the receiving side is reliable. For example, the absolute value of the LLR of each encoded bit is compared to the first threshold T1, and an encoded bit of a lower absolute LLR value than the threshold T1 is decided as a bit of low reliability and an encoded bit of a higher absolute LLR value higher than the first threshold T1 is decided as a bit of high reliability.

The second threshold T2 is compared to the number of bits of low reliability decided using first threshold T1. The receiving side determines which of conventional RB-HARQ, TYPE II HARQ and pocketing RB-HARQ according to the present invention is used, based on the comparison result between the number of bits of low reliability decided using the first threshold T1 and the second threshold T2. The second threshold T2 is determined by channel quality information (“CQI”).

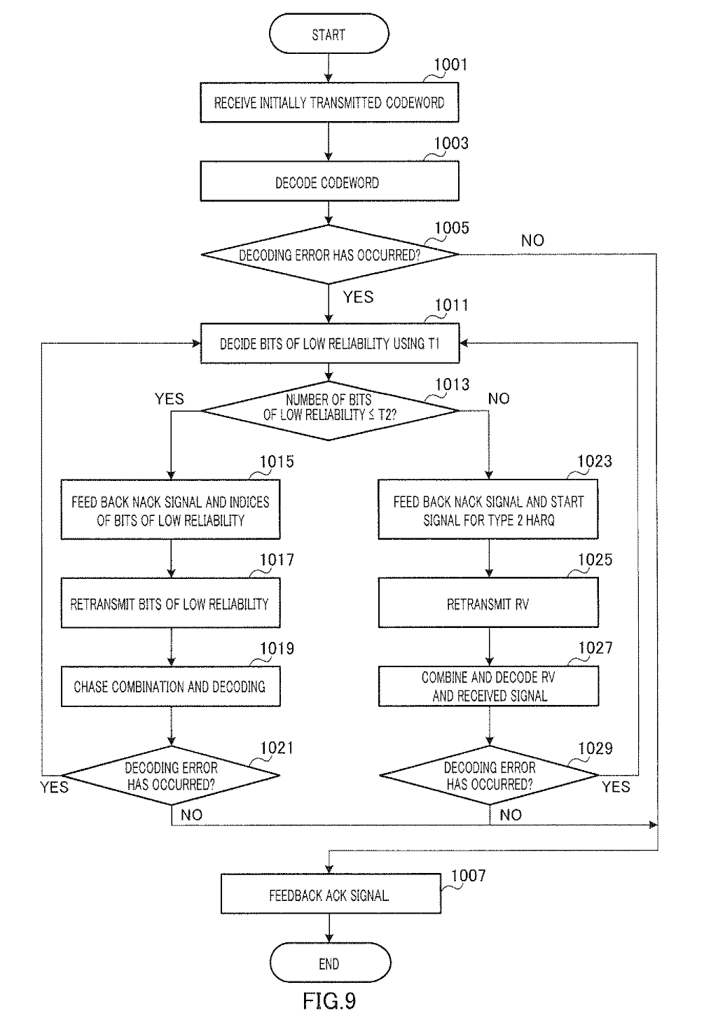

FIG. 9 is a flowchart showing the steps of selecting one of conventional RB-HARQ and conventional TYPE II HARQ and performing a retransmission.

First, in step 1001, the receiving side receives the channel coding codeword initially transmitted from the transmitting side. Here, although a convolutional code, turbo code, LDPC code or RA (Repeat Accumulate) code is used as the channel coding codeword, the channel coding codeword is not limited to these.

Next, in step 1003, the receiving side decodes the received codeword. Further, in step 1005, the receiving side decides whether or not a decoding error has occurred.

If the receiving side decides that a decoding error has not occurred in step 1005 (“NO” in step 1005), in step 1007, the receiving side feeds back an ACK signal to the transmitting side, and the transmitting side having received the ACK signal starts the next, new transmission.

By contrast, if the receiving side decides that a decoding error has occurred in step 1005 (“YES” in step 1005), in step 1011, the receiving side decides the reliability of each encoded bit included in the channel coding codeword using the first threshold T1, and counts the number of bits of low reliability.

Next, in step 1013, the receiving side decides whether or not the number of bits of low reliability is equal to or less than the second threshold T2.

In step 1013, if the receiving side decides that the number of bits of low reliability is equal to or less than the second threshold T2 (“YES” in step 1013), it means that there are few bits of low reliability in the received codeword. In this case, by feeding back only the bit indices of bits of low reliability using conventional RB-HARQ and retransmitting the bits of low reliability in the condition where the amount of feedback information is little, it is possible to achieve better error rate performance. Therefore, in this case, the receiving side and transmitting side perform retransmission operations of conventional RB-HARQ following steps 1015 to 1021.

In step 1015, the receiving side feeds back a NACK signal and the bit indices of bits of low reliability to the transmitting side.

Next, in step 1017, the transmitting side retransmits the bits of low reliability matching the bit indices fed back from the receiving side.

Next, in step 1019, the receiving side receives the retransmitted bits of low reliability, chase-combines the received bits and the encoded bits of the channel coding codeword received previously and further decodes the combination result.

Next, in step 1021, the receiving side decides whether or not a decoding error has occurred.

If the receiving side decides that a decoding error has not occurred in step 1021 (“NO” in step 1021), the step proceeds to step 1007.

By contrast, if the receiving side decides that a decoding error has occurred (“YES” in step 1021), the step returns to step 1011.

On the other hand, in step 1013, if the receiving side decides that the number of bits of low reliability is greater than the second threshold T2 (“NO” in step 1013), it means that there are many bits of low reliability in the received codeword. Here, if conventional RB-HARQ is used, a large amount of bit index information about bits of low reliability needs to be fed back. Therefore, in this case, by using TYPE II HARQ rather than conventional RB HARQ and reducing the coding rate of the channel coding codeword, the communication system can provide better error correction performance and acquire the correct decoding result. To be more specific, the receiving side and transmitting side perform retransmission operations of TYPE II HARQ following steps 1023 to 1029.

In step 1023, the receiving side feeds back a NACK signal and start signal for TYPE II HARQ to the transmitting side.

Next, in step 1025, the transmitting side retransmits a redundancy version.

Next, in step 1027, the receiving side receives the retransmitted redundancy version, combines it and the channel coding codeword received previously, and decodes the combination result.

Next, in step 1029, the receiving side decides whether or not a decoding error has occurred.

If the receiving side decides that decoding error is not caused in step 1029 (“NO” in step 1029), the step proceeds to step 1007.

By contrast, if the receiving side decides that a decoding error has occurred in step 1029 (“YES” in step 1029), the step returns to step 1011.

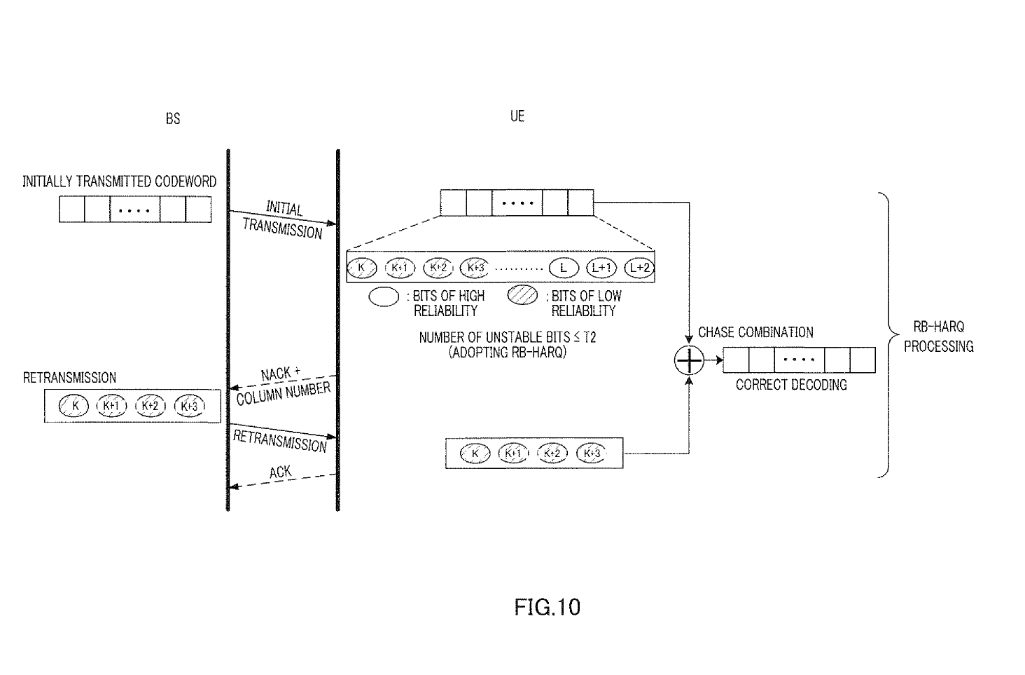

FIG. 10 is a diagram illustrating a state where RB-HARQ is selected to perform a retransmission when the number of bits of low reliability is equal to or less than the threshold T2 in step 1013 of FIG. 9. FIG. 10 adopts an example case where LDPC is used as the channel coding codeword and where the column number is fed back as the bit index of an encoded bit of low reliability.

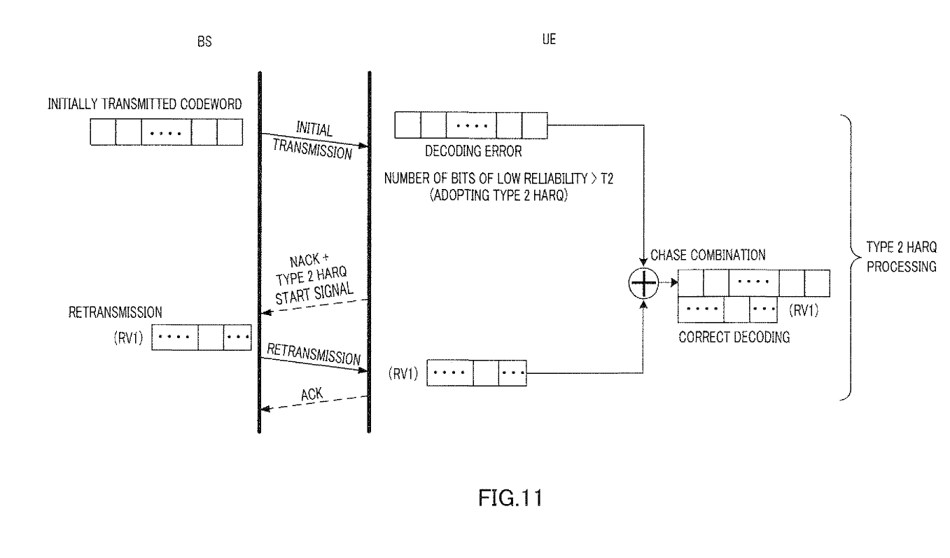

FIG. 11 is a diagram illustrating a state where TYPE II HARQ is selected to perform a retransmission when the number of bits of low reliability is greater than the second threshold T2 in step 1013 of FIG. 9.

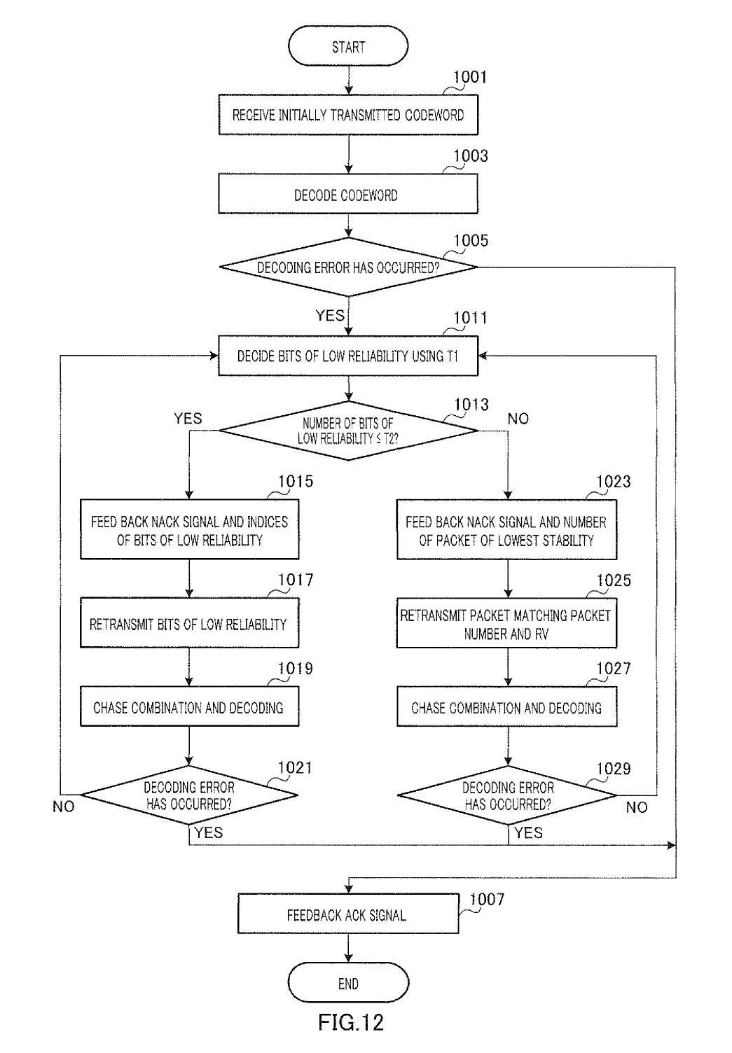

FIG. 12 is a flowchart showing the steps of selecting one of conventional RB-HARQ and pocketing RB-HARQ according to the present invention to perform a retransmission. Here, in FIG. 12, the same steps as in FIG. 9 will be assigned the same reference numerals and their explanation will be omitted.

In step 1013, if the receiving side decides that the number of bits of low reliability is greater than the second threshold 2 (“NO” in step 1013), it means that there are many bits of low reliability in the received codeword. Here, if conventional RB-HARQ is used, a large amount of bit index information about bits of low reliability needs to be fed back. Therefore, in this case, by using pocketing RB-HARQ according to the present invention rather than conventional RB-HARQ and reducing the coding rate of the channel coding codeword, the system can provide better error correction performance and achieve the correct decoding result. To be more specific, the receiving side and transmitting side perform retransmission operations of pocketing RB-HARQ of the present invention, following steps 1223 to 1029.

In step 1223, the receiving side feeds back the packet number of the packet of the lowest reliability to the transmitting side.

Next, in step 1225, the transmitting side retransmits the encoded bits included in the packet matching the packet number fed back from the receiving side, and redundancy version.

Next, in step 1227, the receiving side chase-combines the retransmitted redundancy version, the encoded bits included in the retransmitted packet and the channel coding codeword previously received, and further decodes the combination result.

Another aspect of the present invention adopts a method of realizing a hybrid retransmission based on reliability, the method including the steps of: dividing a channel coding codeword into a plurality of packets each comprised of one or a plurality of encoded bits; in the receiving side, when a decoding error has occurred on the receiving side, selecting the packet of the lowest reliability amongst all packets of the codeword; in the receiving side, feeding back position information of the selected packet of the lowest reliability and a negative acknowledgement (NACK) signal to the transmitting side, and reporting to the transmitting side to start retransmission processing because a decoding error has occurred; and in the transmitting side, retransmitting all encoded bits in the packet matching the position information and a redundancy version, based on the position information and NACK signal fed back from the receiving side.

Another aspect of the present invention adopts a method according to the above-described aspect, in which the redundancy version is used to provide an extra redundancy check bit to the codeword and provide a codeword of a lower coding rate than the coding rate of the codeword previously transmitted.

Another aspect of the present invention adopts a method according to the above-described aspect, in which the redundancy version is a redundancy version based on TYPE II HARQ.

Another aspect of the present invention adopts a method according to the above-described aspect, in which the position information about the packet is the packet number.

Another aspect of the present invention adopts a method according to the above-described aspect, further including the steps of: in the receiving side, performing a chase combination using encoded bits of the packet retransmitted by the transmitting side and encoded bits received earlier, and further combining a result of the chase combination and a redundancy version to produce a new codeword; and performing decoding operations of the new codeword in the receiving side.

Another aspect of the present invention adopts a method according to the above-described aspect, further including the steps of: when the decoding result is correct, feeding back an acknowledgement (ACK) signal from the receiving side to the transmitting side; and when the decoding result is not correct, repeating a feedback and retransmission until the decoding result is correct or until the number of retransmissions reaches the maximum number of retransmissions defined in the system.

Another aspect of the present invention adopts a method according to the above-described aspect, further including the step of, if correct decoding cannot still be realized even when the number of retransmissions reaches the maximum number of retransmissions defined in the system, feeding back another negative acknowledgement signal from the receiving side to the transmitting side and requesting the transmitting side to retransmit the codeword.

Another aspect of the present invention adopts a method according to the above-described aspect, in which the step of selecting the packet of the lowest reliability amongst all packets of the codeword in the receiving side, includes the step of calculating the average value of the absolute values of the logarithm likelihood ratios of the encoded bits included in each packet of the codeword, and selecting the packet of the lowest average value as the packet of the lowest reliability.

Another aspect of the present invention adopts a method of realizing a hybrid automatic retransmission by selection, further including the steps of: if a decoding error has occurred in the receiving side and the number of unstable bits in the encoded bits of a received channel coding codeword is decided to be smaller than a predetermined threshold, performing a hybrid automatic retransmission using a hybrid automatic retransmission method RB-HARQ based on reliability; and if the number of bits of low reliability in the encoded bits is greater than a predetermined threshold, performing a hybrid automatic retransmission using TYPE II HARQ or the hybrid automatic retransmission method based on reliability according to the present invention.

Another aspect of the present invention adopts a method according to the above-described aspect, in which the threshold is determined based on the channel condition.

Another aspect of the present invention adopts a method according to the above-described aspect, further including the step of, when the absolute value of the logarithm likelihood ratio (LLR) of an encoded bit is less than another threshold, deciding the encoded bit as a bit of low reliability.

Another aspect of the present invention adopts a configuration of a transmitting apparatus that realizes a hybrid automatic retransmission based on reliability and that divides a channel coding codeword into a plurality of packets each comprised of one or a plurality of encoded bits, the transmitting apparatus including: an encoder that performs channel coding of a data bit stream and transmits a channel coding codeword to a modulating section and retransmission information storage section; the modulating section that modulates the channel coding codeword; the retransmission information storage section that stores a plurality of redundancy versions and packet information of the channel coding codeword; and a retransmission control section that, upon receiving position information about the packet of the lowest reliability and negative acknowledgement (NACK) signal for use to report a decoding error, fed back from the receiving side, reads out all encoded bits in the packet matching the position information in the retransmission information storage section, and a supporting redundancy version, transmits the encoded bits and the redundancy version to the modulating section and retransmits these.

Another aspect of the present invention adopts a system of realizing a hybrid automatic retransmission based on reliability and dividing a channel coding codeword into a plurality of packets each comprised of one or a plurality of encoded bits, in which this system is provided with the transmitting apparatus and the receiving apparatus, the receiving apparatus including: a receiving antenna that receives a modulation symbol stream transmitted from the transmitting side; a demodulating section that demodulates the received modulation symbol stream; a decoding section that performs channel coding of data from the modulating section; and a retransmission decider that, when it is determined that decoding result in the decoding section is not correct, feeds back position information about the packet of the lowest reliability in all packets of the codeword, and a negative acknowledgement (NACK) to report an occurrence of a decoding error, to a retransmission control section.

Although a case has been described with the above embodiment as an example where the present invention is implemented with hardware, the present invention can be implemented with software. For example, by describing the algorithm of processing of the stereo speech coding method according to the present invention in a programming language, storing this program in a memory and making the information processing section execute this program, it is possible to implement the same function as the stereo speech coding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Chinese Patent Application No. 200710091776.9, filed on Apr. 11, 2007, including the specification, drawings and abstract, is incorporated herein by reference in its entirety.

### INDUSTRIAL APPLICABILITY

The retransmission method, communication system and transmitting apparatus of the present invention are applicable to mobile communication systems, and so on.

1. A retransmission method comprising:
a generating step of, in a transmitting side, packetizing a channel coding codeword and generating a plurality of packets comprised of one or a plurality of encoded bits included in the channel coding codeword;
an initial transmission step of, in the transmitting side, performing an initial transmission of the channel coding codeword;
an initial decoding step of, in a receiving side, receiving and performing initial decoding of the channel coding codeword;
an initial selection step of, when a decoding error has occurred in the initial decoding step, selecting one packet of the lowest reliability amongst the plurality of packets;
a packet number feedback step of feeding back a negative acknowledgement signal and a packet number of the selected one packet from the receiving side to the transmitting side; and
a packet retransmitting step of, in the transmitting side, retransmitting encoded bits included in a packet matching the packet number and a redundancy version.

2. The retransmission method according to claim 1, wherein the redundancy version comprises an extra redundancy check bit corresponding to a codeword of the selected one packet.

3. The retransmission method according to claim 2, wherein the redundancy version comprises a redundancy version based on a type II hybrid automatic retransmission request.

4. The retransmission method according to claim 1, further comprising:
a combining step of, in the receiving side, performing a chase combination using the encoded bits retransmitted in the retransmitting step and the encoded bits included in the channel coding codeword transmitted in the initial transmission step, and further combining a result of the chase combination and the redundancy version to produce a combined codeword;
a post-combination decoding step of, in the receiving side, decoding the combined codeword; and
a post-combination selecting step of, when a decoding error has occurred in the post-combination decoding step, selecting one packet of the lowest reliability in the plurality of packets.

5. The retransmission method according to claim 4, further comprising:
a repeating step of repeating the post-combination selecting step, the packet number feedback step, the packet retransmitting step, the combining step and the post-combination decoding step, until the decoding error does not occur in the post-combination decoding step or until the number of times the retransmission step is performed reaches a maximum number of retransmissions; and
an acknowledgement signal feedback step of, when the decoding error has not occurred in the post-combination decoding step, feeding back an acknowledgement signal from the receiving side to the transmitting side.

6. The retransmission method according to claim 5, further comprising a negative acknowledgement signal feedback step of, when the decoding error has still occurred in the post-combination decoding step, feeding back a negative acknowledgement signal from the receiving side to the transmitting side.

7. The retransmission method according to claim 1, wherein, in the initial selection step, the receiving side calculates an average value of absolute values of logarithm likelihood ratios of encoded bits included in each packet, and selects one packet of the lowest average value as the packet of the lowest reliability.

8. A retransmission method comprising:
a generating step of, in a transmitting side, packetizing a channel coding codeword and generating a plurality of packets comprised of one or a plurality of encoded bits included in the channel coding codeword;
an initial transmission step of, in the transmitting side, performing an initial transmission of the channel coding codeword;
an initial decoding step of, in a receiving side, receiving and performing initial decoding of the channel coding codeword;
a calculating step of, when a decoding error has occurred in the initial decoding step, deciding a reliability of each encoded bit included in the channel coding codeword and calculating the number of bits of low reliability;
a position information feedback step of, in the receiving side, when the number of bits of low reliability is equal to or less than a first threshold, feeding back a negative acknowledgement signal and information about positions of the bits of low reliability;
a packet number feedback step of, in the receiving side, when the number of bits of low reliability is greater than the first threshold, selecting one packet of the lowest reliability and feeding back a negative acknowledgement signal and a packet number of the selected one packet to the transmitting side;
a bit retransmitting step of, in the transmitting side, when the negative acknowledgement signal and the information about the positions of the bits of low reliability are fed back from the receiving side, retransmitting the bits of low reliability based on the information about the positions of the bits of low reliability; and
a packet retransmitting step of, in the transmitting side, when the negative acknowledgement signal and the packet number are fed back from the receiving side, retransmitting encoded bits included in a packet matching the packet number and a redundancy version.

9. The retransmission method according to claim 8, wherein the first threshold is determined based on channel quality information.

10. The retransmission method according to claim 8, wherein, in the calculating step, the receiving side decides the encoded bit of an absolute value of logarithm likelihood ratio less than a second threshold, as a bit of low reliability.

11. A retransmission method comprising:
a generating step of, in a transmitting side, packetizing a channel coding codeword and generating a plurality of packets comprised of one or a plurality of encoded bits included in the channel coding codeword;
an initial transmission step of, in the transmitting side, performing an initial transmission of the channel coding codeword;
an initial decoding step of, in a receiving side, receiving and performing initial decoding of the channel coding codeword;
a calculating step of, when a decoding error has occurred in the initial decoding step, deciding a reliability of each encoded bit included in the channel coding codeword and calculating the number of bits of low reliability;
a position information feedback step of, in the receiving side, when the number of bits of low reliability is equal to or less than a first threshold, feeding back a negative acknowledgement signal and information about positions of the bits of low reliability;
a start signal feedback step of, in the receiving side, when the number of bits of low reliability is greater than a predetermined threshold, feeding back a negative acknowledgement signal and a start signal for a type II hybrid automatic retransmission request to the transmitting side;
a bit retransmitting step of, in the transmitting side, when the negative acknowledgement signal and the information about the positions of the bits of low reliability are fed back from the receiving side, retransmitting the bits of low reliability based on the information about the positions of the bits of low reliability; and
a redundancy version retransmitting step of, in the transmitting side, when the negative acknowledgement signal and the start signal for the type II hybrid automatic retransmission request are fed back from the receiving side, retransmitting a redundancy version.

12. A communication system comprising a transmitting apparatus and receiving apparatus, wherein:
the transmitting apparatus comprises:
a generating section that packetizes a channel coding codeword and generates a plurality of packets comprised of one or a plurality of encoded bits included in the channel coding codeword;
an initial transmission section that performs an initial transmission of the channel coding codeword; and
a packet retransmitting section that, when a packet number and negative acknowledgment signal are fed back from the receiving apparatus, retransmits encoded bits included in a packet matching the packet number and a redundancy version; and
the receiving apparatus comprises:
a decoding section that receives and decodes the channel coding codeword;
an initial selection section that, when a decoding error has occurred in the decoding step, selects one packet of the lowest reliability amongst the plurality of packets; and
a packet number feedback section that feeds back the negative acknowledgement signal and the packet number of the selected one packet to the transmitting apparatus.

13. A transmitting apparatus comprising:
a generating section that packetizes a channel coding codeword and generates a plurality of packets comprised of one or a plurality of encoded bits included in the channel coding codeword;
an initial transmission section that performs an initial transmission of the channel coding codeword; and
a packet retransmitting section that, when a packet number and negative acknowledgment signal are fed back from a receiving apparatus, retransmits encoded bits included in a packet matching the packet number and a redundancy version.
